(19) United States
(12) Patent Application Publication
(10) Pub. No.: US 2011/0194419 A1
(43) Pub. Date: Aug. 11, 2011

(54) WIRELESS COMMUNICATION SYSTEM FOR EFFICIENT MULTICAST TRANSMISSION USING ADAPTIVE MODULATION AND CODING MECHANISM

(75) Inventors: Jong Min Lee, Daejeon (KR); Joo Hyung Lee, Daejeon (KR); Jun Kyun Choi, Daejeon (KR)

(73) Assignee: Korea Advanced Institute of Science and Technology, Daejeon (KR)

(21) Appl. No.: 12/894,126

(22) Filed: Sep. 29, 2010

(30) Foreign Application Priority Data
Feb. 6, 2010 (KR) 10-2010-0017908
Aug. 3, 2010 (KR) 10-2010-0074847

(51) Int. Cl. H04L 12/26; H04H 20/71

(52) U.S. Cl. 370/242; 370/312

(57) ABSTRACT

Disclosed is a wireless communication system for efficient multicast transmission using an AMC scheme. The wireless communication system and the AMC scheme enable a user participating in a multicast group to be provided with efficient service, and provide more users with a multicast broadcast service through the AMC scheme using a proposed group MCS level determination algorithm.

### CROSS-REFERENCE TO RELATED APPLICATION

This application claims priority to and benefit of Korean Patent Applications No. 10-2010-0017908, filed on Feb. 26, 2010, and No. 10-2010-0074847, filed on Aug. 3, 2010, in the Korean Intellectual Property Office, the disclosure of which is expressly incorporated herein by reference.

### BACKGROUND

1. Field of the Invention

The present invention relates to a wireless communication system for efficient multicast transmission using adaptive modulation and coding (AMC) scheme, and more particularly, to a wireless communication system for efficient multicasting using an AMC mode and a diversity mode, and a scheduling method.

2. Description of the Related Art

An Adaptive Modulation and Coding (AMC) scheme is used as a technique to efficiently use a wireless channel by determining a different modulation and coding selection (MCS) level based on a channel state of a user in a wireless system. However, when joining the AMC scheme to a broadcast service, that is, a multicast method, a proper modulation and coding scheme to enable all mobile terminals in a group to receive a stream without error is selected so that the stream is transmitted to all mobile terminals participating in the group. That is, the stream is transmitted with an MCS level being determined based on a user having an inferior channel state in the group. In a multicast scheme, one data stream is shared by a plurality of users in the same group. Thus, so that all users in the group are provided with a service, the data stream is transmitted using a modulation, and a coding rate is determined based on a user having an inferior channel in the group. When a number of users in a cell coverage increases, a performance of the multicast scheme increases in an early stage, however, gradually becomes saturated. Thus, for efficient multicast transmission in a wireless network, there is a need for a technique to adapt an existing AMC scheme for multicast transmission.

FIG. 1 illustrates a performance of a multicast transmission system when a number of users and a cell radius are changed according to a related art. In a graph 110, an x-axis represents a number of users in a cell coverage, and a y-axis represents the performance in bps/Hz. A table 120 indicates analysis and simulation values depending on the cell radius in the graph 110. As shown in the graph 110, as the number of the users increases, the performance changes in an early stage and gradually becomes gradually. Here, the performance is increased or decreased, depending on a cell radius.

In order to overcome the above problem of the multicast scheme, various multicast grouping methods (scheduling methods) have been proposed, however, such grouping methods do not allow mobile terminals which do not satisfy a predetermined standard to be provided with a multicast service.

Accordingly, there is desire for a system and a method to allocate effective multicast sub-carriers.

### SUMMARY

An aspect of the present invention provides a wireless communication system and a multicast AMC scheme which enables a user participating in a multicast group to be provided with efficient service, and provides more users with a multicast broadcast service.

Another aspect of the present invention also provides a wireless communication system and a scheduling method which enables all users participating in a multicast group to be provided with efficient service, and provides all of the users with a multicast service without missing any user.

Still another aspect of the present invention also provides a method of providing a multicast stream by determining an MCS level of each group using information about a channel state of each mobile terminal in a system based on a saturation of the system and using a multicast group MCS level determination algorithm and by using an efficient AMC scheme.

A further aspect of the present invention also provides a user mobile terminal group classification unit provides a multicast stream by applying information about a channel state of each of a plurality of user mobile terminals and an average transmission rate to a proposed group MCS level determination algorithm to maximize channel efficiency.

Another aspect of the present invention also provides a wireless communication system raises an MCS level of a multicast channel having a low channel efficiency to increase efficiency of a wireless channel since transmission needs to be performed at an optimal efficiency of a channel when a system is in a congestion state, the efficiency of each multicast channel being calculated based on a multicast channel efficiency calculation algorithm.

According to an aspect of the present invention, a wireless communication system includes a user mobile terminal group classification unit to classify a plurality of user mobile terminals into two groups using a group AMC level determination algorithm, a first multicast unit to provide a multicast stream in an AMC mode to a user mobile terminal in one group of the two groups, and a second multicast unit to provide a multicast stream in a diversity mode to a user mobile terminal in another one group of the two groups.

The user mobile terminal group classification unit may classify the plurality of user mobile terminals into one user mobile terminal group and another user mobile terminal group, the one user mobile terminal group including user mobile terminals selected by applying information about a channel state of each of the plurality of user mobile terminals and an average transmission rate to the group AMC level determination algorithm.

According to an aspect of the present invention, a wireless communication system includes a user mobile terminal group classification unit to classify a plurality of user mobile terminals into two groups based on a multicast grouping algorithm, a first multicast unit to provide a multicast stream to a user mobile terminal in one group of the two groups, and a second multicast unit to provide a multicast stream to a user mobile terminal in another group of the two groups by transcoding the multicast stream into a low-capacity data stream or scalable video coding.

According to an aspect of the present invention, a scheduling method includes classifying a plurality of user mobile terminals into two groups using a group AMC level determination algorithm; providing a multicast stream in an AMC mode to a user mobile terminal in one group of the two groups, and providing a multicast stream in a diversity mode to a user mobile terminal in another one group of the two groups.

According to an aspect of the present invention, a scheduling method includes classifying a plurality of user mobile terminals into two groups using a multicast grouping algorithm, transmitting a multicast stream to a user mobile terminal in one group of the two groups, and providing a multicast stream to a user mobile terminal in another one group of the two groups by transcoding the multicast stream into a low-capacity data stream or scalable video coding.

As described above, an aspect of embodiments of the present invention enables a user participating in a multicast group to be provided with efficient service, and provides more users with a multicast service by enhancing resource efficiency of a system optimally.

Further, an aspect of embodiments of the present invention also enables all users participating in a multicast group to be provided with efficient service, and provides all of the users with a multicast service without missing any user.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a performance of a multicast transmission system when a number of users and a cell radius are changed according to a related art;

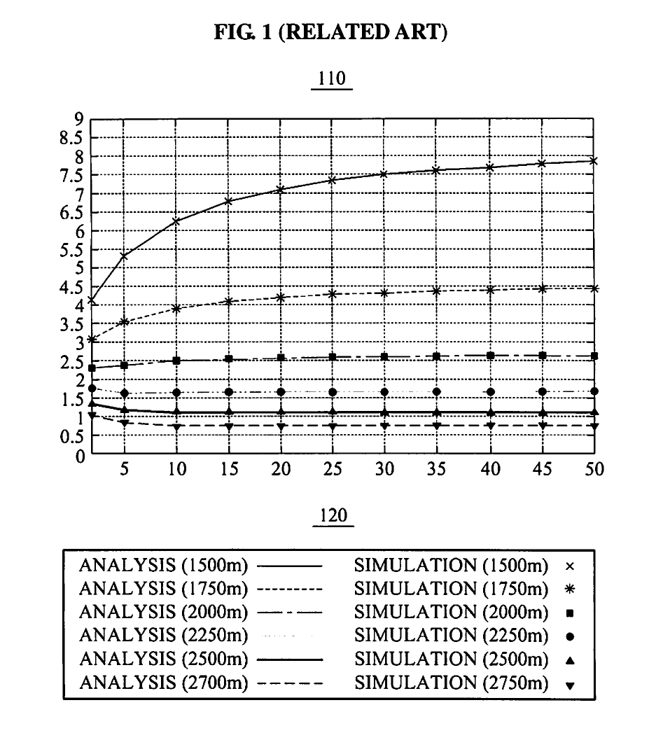

FIG. 2 shows an example illustrating a modulation method according to a distance from a base station based on pass loss and a distribution of mobile terminals;

FIG. 3 shows an example illustrating a process of extracting a multicast group MCS level using a multicast group MCS level determination algorithm according to an embodiment of the present invention;

FIG. 4 is a table illustrating a relation between an MCS level of a wireless communication system and an allocated resource according to an embodiment of the present invention;

FIG. 5 is a flowchart illustrating a scheduling method according to an embodiment of the present invention;

FIG. 6 is a flowchart illustrating a scheduling method according to an embodiment of the present invention;

FIG. 7 shows an example illustrating a process of extracting a multicast group user using a group AMC level determination algorithm according to an embodiment of the present invention;

FIG. 8 is a block diagram illustrating a configuration of a wireless communication system according to an embodiment of the present invention;

FIG. 9 is a flowchart illustrating a scheduling method according to an embodiment of the present invention; and

FIG. 10 is a flowchart illustrating a scheduling method according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Exemplary embodiments of the present invention may provide efficient multicast streaming to selected mobile terminals using a group modulation and coding selection (MCS) level determination algorithm.

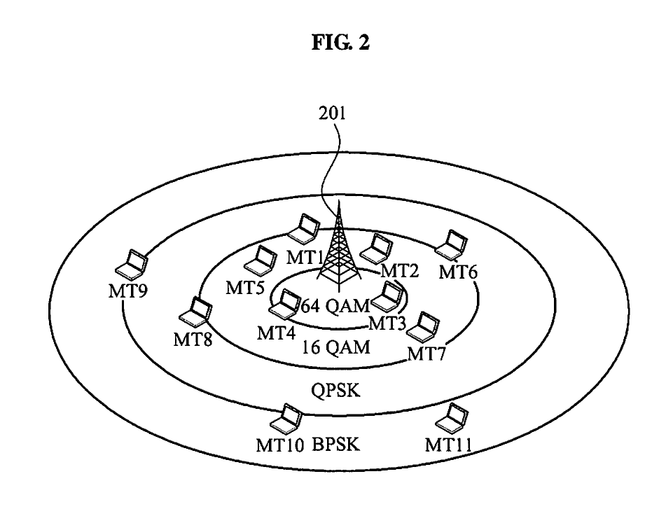

FIG. 2 shows an example illustrating a modulation method according to a distance from a base station based on pass loss and a distribution of mobile terminals. As shown in FIG. 2, the worse a channel environment becomes, the farther a distance from a base station 201 is, and thus a lower modulation scheme is used to transmit data. That is, in the example shown in FIG. 2, data transmission is performed using 64 Quadrature Amplitude Modulation (QAM) 16 QAM, Quadrature Phase Shift Keying (QPSK), and Binary Phase Shift Keying (BPSK) in order. An example of a distribution of eleven mobile terminals MT1 to MT11 on the base station 210 is shown in FIG. 2.

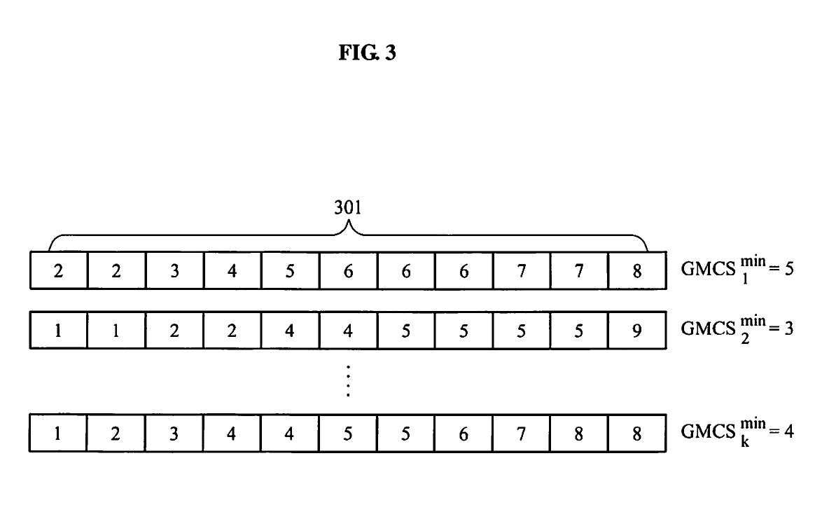

FIG. 3 shows an example illustrating a process of extracting a multicast group MCS level using a multicast group MCS level determination algorithm according to an embodiment of the present invention. FIG. 3 illustrates GMCSₖ^{min} that is a minimum MCS level in a group among transmission rates of a first mobile terminal to an eleventh mobile terminal included in each of k groups. For example, a first group 301 has a minimum MCS level, which is GMCS₁^{min}, of 5.

Here, mobile terminals having maximum efficiency in a multicasting may be extracted using the proposed group MCS level determination algorithm. In the present embodiment, as shown in FIG. 3, a minimum transmission rate GMCSₖ^{min} in each group among the transmission rates of the first mobile terminal to the eleventh mobile terminal in each group is measured to find a maximum grouping point which satisfies conditions of the proposed group MCS level determination algorithm, and a multicast stream may be transmitted to selected mobile terminals in a determined MCS mode.

Hereinafter, an example of the conditions of the group MCS level determination algorithm will be described. The conditions are expressed by the following Equation 1. First, the group MCS level determination algorithm may determine a minimum MCS level of a user in a group as an MCS level of a multicast group, when a saturation of a system resource does not exceed a predetermined saturation as shown in Equation 1.

GMCSₖ(t+1)=min{UMCSᵢ|iεUₖ} [Equation 1]

Here, k is a multicast group index representing a multicast group in one cell, and GMCSₖ represents an MCS level of a k^{th} group. UMCSᵢ represents an MCS level of a user i, and Uₖ represents a set of users i in the k^{th} group.

Further, the group MCS level determination algorithm may need to manage a multicast group based on channel efficiency as shown in Equations 2 and 3 when the saturation of the system is more than a preset value, for example, 60% of capacity, 70% of capacity, 80% of capacity, and the like. Through the management, a multicast stream may be efficiently provided to as many users as possible.

$$j = {arg max}_{1 \leq j \leq MCS max} \{ \frac{{N}_{k}}{n ( {MCS}_{j} , {R}_{k} )} \} \qquad [ Equation 2 ]$$

Here, k is a multicast group index representing a multicast group in one cell, Rₖ represents a data rate of a multicast stream needed for the k^{th} group, n(MCSⱼ, Rₖ) represents a number of Orthogonal Frequency Division Multiplexing (OFDM) sub-carriers needed when a data rate Rₖ is provided to MCSⱼ, and Nₖ represents a number of users having an MCS level which is the same as or higher than MCSⱼ among users in the k^{th} group. Thus, GMCSₖ that is an MCS level of the k^{th} group may be determined by the following Equation 3 and be updated by a preset slot t, e.g., five milliseconds in Worldwide Interoperability for Microwave Access (WiMAX).

GMCSₖ(t+1)=j [Equation 3]

Here, when a user i is in the k^{th} multicast group, the user i receives multicast data at a transmission rate of GMCSₖ(t) determined by the above equation, and a transmission rate of a next frame may be calculated by GMCSₖ(t+1). Here, a variable MCS value is applied so that when data is transmitted at a high-efficiency transmission speed among transmission speeds of users in the k^{th} multicast group, a maximum number of users in the k^{th} multicast group may receive data without wasting a wireless frequency. Here, a number of users provided with a service may be changed based on a transmission rate of a substituted MCS level, and a multicast group may be constituted by users which can receive a multicast data at the MCS level.

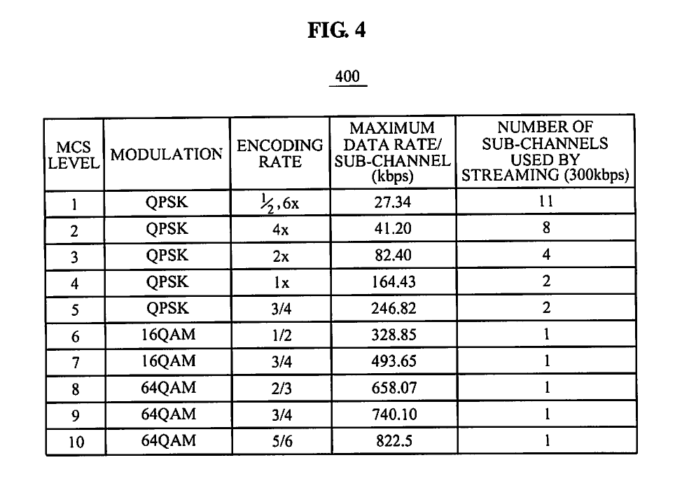

Hereinafter, a wireless system which provides a multicast service by the above process and a scheduling method will be described with reference to FIGS. 4 to 6.

First, a multicast stream may be provided to a mobile terminal in a group selected using a proposed group MCS level determination algorithm in an adaptive modulation and coding (AMC) mode. That is, the multicast stream may be provided efficiently to the user mobile terminals selected using the group MCS level determination algorithm through a bandwidth of the AMC mode using a continuous channel feedback.

Here, a critical value of a saturation may be set by a system operator depending on circumstances. As described above, an MCS level of a group is determined using the group MCS level determination algorithm but may be determined based on when the saturation is more than a preset critical value and when the saturation is not more than preset the critical value. In other words, the critical value may be changed and controlled by the system operator.

FIG. 4 is a table illustrating a relation between an MCS level of a wireless communication system and an allocated resource according to an embodiment of the present invention. Here, FIG. 4 shows an example of setting an MCS level defined by an 802.16 Orthogonal Frequency Division Multiple Access (OFDMA) system. That is, the table in FIG. 4 is just an illustrative example, and systems may be set differently.

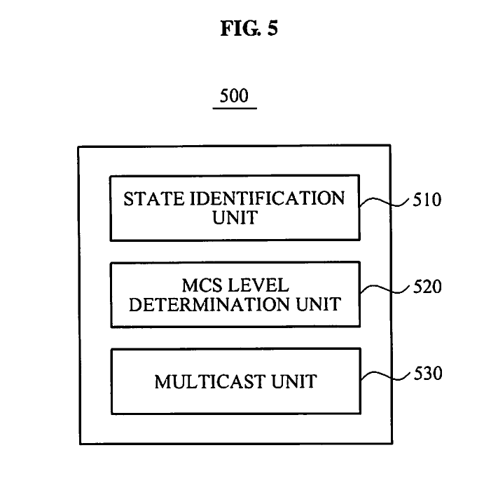

FIG. 5 is a block diagram illustrating a configuration of a wireless communication system according to an embodiment of the present invention. As shown in FIG. 5, the wireless communication system 500 according to the present embodiment includes a state identification unit 510, an MCS level determination unit 520, and a multicast unit 530.

The state identification unit 510 identifies a congestion state of a network in response to a request for a multicast channel. Here, whether the network is in a congestion state may be determined based on a saturation of a resource and a preset critical value of the saturation. The preset critical value may be set by a system operator of the wireless communication system 500 depending on circumstances.

The MCS level determination unit 520 determines an MCS level based on whether the network is in a congestion state. Here, the MCS level determination unit 520 may determine an MCS level using a group MCS level determination algorithm when the network is in a congestion state. For example, the wireless communication system 500 may determine that the network is in a congestion state when the critical value is set to 60% of capacity, and the saturation of the resource is more than 60% of capacity. Here, the MCS level determination unit 520 may determine an MCS level using the group MCS level determination algorithm.

Here, the group MCS level determination algorithm may include an algorithm to determine an MCS level of a group based on a data rate of a multicast stream needed for a group and an MCS level of each user mobile terminal in the group in response to the request for the multicast channel. For example, the group MCS level determination algorithm may be expressed by the above Equations 2 and 3.

Further, the MCS level determination unit 520 determines a minimum MCS level among an MCS level of each mobile terminal in a group as an MCS level of the group in response to the request for the multicast channel when the network is not in a congestion state. For example, the wireless communication system 500 may determine that the network is not in a congestion state when the critical value is set to 60% of capacity and the saturation of the resource is not more than 60% of capacity. Here, the MCS level determination unit 520 may determine a minimum MCS level using the above Equation 1, for example.

The multicast unit 530 provides a multicast stream using the determined MCS level. Here, the multicast unit 530 may transmit the multicast stream in an AMC mode using the determined MCS level. As described above, the multicast unit 530 may select user mobile terminals through the determined MCS level and transmit efficient multicast streaming to the selected user mobile terminals through a bandwidth of the AMC mode using a continuous channel feedback.

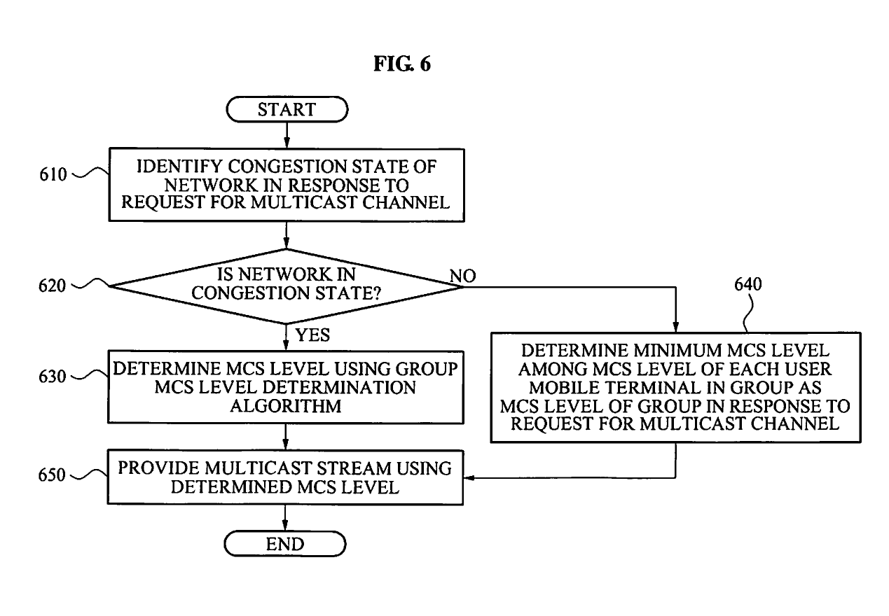

FIG. 6 is a flowchart illustrating a scheduling method according to an embodiment of the present invention. The scheduling method according to the present embodiment may be performed by the wireless communication system 500 described with reference to FIG. 5.

In operation 610, the wireless communication system 500 identifies a congestion state of a network in response to a request for a multicast channel. Here, whether the network is in a congestion state may be determined based on a saturation of a resource and a preset critical value of the saturation. The preset critical value may be set by an administrator of the wireless communication system 500 depending on circumstances.

In operation 620, the wireless communication system 500 may determine whether the network is in a congestion state. When the network is in a congestion state, the wireless communication system 500 performs operation 630. When the network is not in a congestion state, the wireless communication system 500 performs operation 640. That is, the wireless communication system 500 determines an MCS level based on whether the network is in a congestion state.

In operation 630, the wireless communication system 500 may determine an MCS level using a group MCS level determination algorithm when the network is in a congestion state. For example, the wireless communication system 500 may determine that the network is in a congestion state when the critical value is set to 60% of capacity and the saturation of the resource is more than 60% capacity. Here, the wireless communication system 500 may determine an MCS level using the group MCS level determination algorithm.

Here, the group MCS level determination algorithm may include an algorithm to determine an MCS level of a group based on a data rate of a multicast stream needed for a group and an MCS level of each user mobile terminal in the group in response to the request for the multicast channel. For example, the group MCS level determination algorithm may be expressed by the above Equations 2 and 3.

In operation 640, the wireless communication system 500 determines a minimum MCS level among an MCS level of each mobile terminal in a group as an MCS level of the group in response to the request for the multicast channel when the network is not in a congestion state. For example, the wireless communication system 500 may determine that the network is not in a congestion state when the critical value is set to 60% of capacity and the saturation of the resource is not more than 60% of capacity. Here, the wireless communication system 500 may determine a minimum MCS level using the above Equation 1, for example.

In operation 650, the wireless communication system 500 provides a multicast stream using the determined MCS level. Here, the wireless communication system 500 may transmit the multicast stream in the AMC mode using the determined MCS level. As described above, the wireless communication system 500 may select user mobile terminals through the determined MCS level and transmit efficient multicast streaming to the selected user mobile terminals through a bandwidth of the AMC mode using a continuous channel feedback.

That is, the user mobile terminals may be selected using the above group MCS level determination algorithm in response to the request for the multicast channel, and the efficient multicast streaming may be provided to the selected mobile terminals through the bandwidth of the AMC mode using the continuous channel feedback.

As described above, exemplary embodiments of the present invention enable a user participating in a multicast group to be provided with efficient service, and provide more users with a multicast service by enhancing resource efficiency of a system optimally.

Hereinafter, a wireless communication system and a scheduling method to perform an efficient multicast using an AMC mode and a diversity mode according to another embodiment of the present invention will be described.

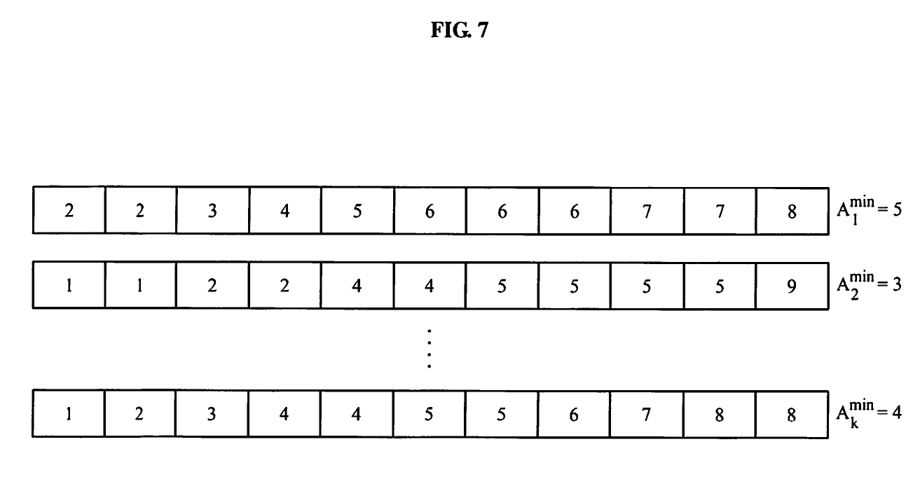

FIG. 7 shows an example illustrating a process of extracting a multicast group user using a group AMC level determination algorithm. In FIG. 7, Aₖ^{min} represents a minimum transmission rate in a group among transmission rates of a first mobile terminal to an eleventh mobile terminal. Here, mobile terminals having maximum efficiency in a multicasting may be extracted using the group AMC level determination algorithm. In the present embodiment, as shown in FIG. 7, a minimum transmission rate Aₖ^{min} in each group among the transmission rates of the first mobile terminal to the eleventh mobile terminal in each group is shifted to find a maximum grouping point which satisfies conditions of the group AMC level determination algorithm, and a multicast stream may be transmitted to selected mobile terminals in a determined AMC mode, and a multicast stream may be transmitted to remaining mobile terminals in a diversity mode. For example, in a first group in FIG. 3, the multicast stream may be transmitted in the AMC mode from a fifth mobile terminal having an AMC level of 5 to an eleventh mobile terminal having an AMC level of 8, and the multicast stream may be transmitted in the diversity mode from a first mobile terminal having an AMC level of 2 to a fourth mobile terminal having an AMC level of 4.

Hereinafter, an example of the conditions of the group AMC level determination algorithm will be described. The conditions are expressed by the following Equation 4. First, the group AMC level determination algorithm is a scheme to maximize a sum of group AMC levels of all users as shown in the following Equation 4.

$${\sum }_{k ∈ G} {GAMC}_{k} \qquad [ Equation 4 ]$$

Here, k is a group index, G represents a whole of multicast groups, and GAMCₖ represents an AMC level of a k^{th} group and may be updated by a slot as shown in the following Equation 5.

$${GAMC}_{k} ( t + 1 ) = min \{ {UAMC}_{i} ( t + 1 ) \vert {UAMC}_{i} ( t + 1 ) \geq ⌊ {\sum }_{i ∈ k} \frac{{UAMC}_{i} ( t + 1 )}{{TM}_{k}} ⌋ \} where i ∈ k \qquad [ Equation 5 ]$$

Here, TMₖ is a number of members in the k^{th} group, k is a multicast group index representing a multicast group in one cell, and UAMCᵢ represents an AMC level of each user. When a user i is in the k^{th} multicast group, the user i receives multicast data at a transmission to rate of AMCₖ(t) determined by the above equation, and a transmission rate of a next frame may be calculated by AMCₖ(t+1). Here, a variable AMC value is applied so that when data is transmitted at a high-efficiency transmission speed among transmission speeds of users in the k^{th} multicast group, a maximum number of users in the k^{th} multicast group may receive data without wasting a wireless frequency. Here, a number of users provided with a service may be changed based on a transmission rate of a substituted AMC level, and a multicast group may be constituted by users which can receive a multicast data at the AMC level.

$$\{ \begin{matrix}{U}_{A} = \{ i \vert {{UAMC}_{i}}_{i ∈ k} \geq {GAMC}_{k} \} \\ {U}_{D} = \{ i \vert {{UAMC}_{i}}_{i ∈ k} < {GAMC}_{k} \}\end{matrix} \qquad [ Equation 6 ]$$

Here, a modulation of each multicast group may be determined by Equation 5, and users may be divided into an AMC mode user and a diversity mode user by Equation 6. Users which are not in U_{A}, that is, users in a U_{D} group, transmit a multicast stream in a diversity mode, as described above, thereby enabling all users participating in the multicast group to be provided with efficient service, and providing all of the users with a multicast service without missing any user.

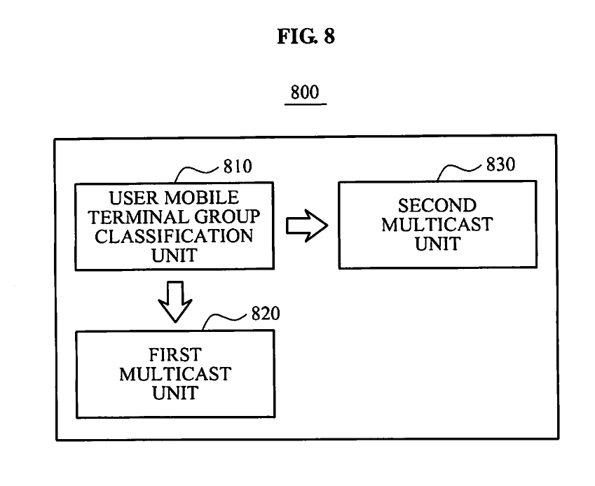

Hereinafter, a wireless system which provides a multicast service by the above process and a scheduling method will be described with reference to FIGS. 8 to 10.

FIG. 8 is a block diagram illustrating a configuration of a wireless communication system according to an embodiment of the present invention. As shown in FIG. 8, the wireless communication system 800 according to the present embodiment includes a user mobile terminal group classification unit 810, a first multicast unit 820, and a second multicast unit 830.

The user mobile terminal group classification unit 810 classifies a plurality of user mobile terminals into two groups using a group AMC level determination algorithm. Here, the group AMC level determination algorithm may include an algorithm to select a user mobile terminal based on an AMC distribution of each of the user mobile terminals. Here, the user mobile terminals may include the mobile terminal described with reference to FIGS. 2 and 7. A method of classifying a plurality of user mobile terminals into two groups using the group AMC level determination algorithm may refer to FIG. 7. For example, the user mobile terminal group classification unit 810 may classify the plurality of user mobile terminals into one user mobile terminal group and another user mobile terminal group, the one user mobile terminal group including user mobile terminals selected by applying information about a channel state of each of the plurality of user mobile terminals and an average transmission rate to the group AMC level determination algorithm.

The first multicast unit 820 provides a multicast stream in an AMC mode to a user mobile terminal in one group of the two groups. That is, efficient multicast streaming may be provided to user mobile terminals selected by the group AMC level determination algorithm through a bandwidth of an AMC mode using a continuous feedback.

The second multicast unit 830 provides a multicast stream in a diversity mode to a user mobile terminal in another group of the two groups. That is, provision of multicast streaming to user mobile terminals which are not selected by the group AMC level determination algorithm, i.e., user mobile terminals with an inferior channel environment, may be more effective in a frequency use efficiency of a diversity mode using a diversity gain than in the AMC mode using the continuous channel feedback. Thus, the multicast streaming is provided using a bandwidth of the diversity mode to comparatively efficiently provide a multicast service to all user mobile terminals.

Alternatively, the wireless communication system 800 may include a user mobile terminal group classification unit 810 to classify a plurality of user mobile terminals into two groups based on a multicast grouping algorithm, a first multicast unit 820 to provide a multicast stream to a user mobile terminal in one group of the two groups, and a second multicast unit 830 to provide a multicast stream to a user mobile terminal in another group of the two groups by transcoding the multicast stream into a low-capacity data stream or scalable video coding. That is, the wireless communication system 800 classifies a plurality of user mobile terminals into two groups, immediately transmits a multicast stream to user mobile terminals in one group, and transmits a multicast stream by changing the multicast stream into a low-capacity data stream or transmits a lowest class through scalable video coding to user mobile terminals in another group, thereby enabling provision of a multicast service even to user mobile terminals having an inferior channel state. Here, for example, the multicast grouping algorithm may include the aforementioned group AMC level determination algorithm, and the user mobile terminal group classification unit 810 classifies the plurality of user mobile terminals into one user mobile terminal group and another user mobile terminal group, the one user mobile terminal group including user mobile terminals selected by applying information about a channel state of each of the plurality of user mobile terminals and an average transmission rate to the group AMC level determination algorithm.

Although grouping a plurality of user mobile terminals is performed using the group AMC level determination algorithm in the above example, a plurality of user mobile terminals may be grouped using a preset critical value by an administrator as necessary into user mobile terminals having a critical value more than the preset critical value and user mobile terminals having a critical value not more than the preset critical value. In other words, any one of well-known multicast grouping schemes may be used as a grouping algorithm.

As an example of provision of a multicast stream, the first multicast unit 820 may provide a multicast stream in an AMC mode to a user mobile terminal in the one group, and the second multicast unit 830 may provide a multicast stream in a diversity mode to a user mobile terminal in the other group. However, the above example is just an illustrative example, but the first multicast unit 820 and the second multicast unit 830 may transmit a multicast stream to a user mobile terminal in a group by different multicast transmission methods having different use efficiencies based on transmission rates or channel environments, respectively.

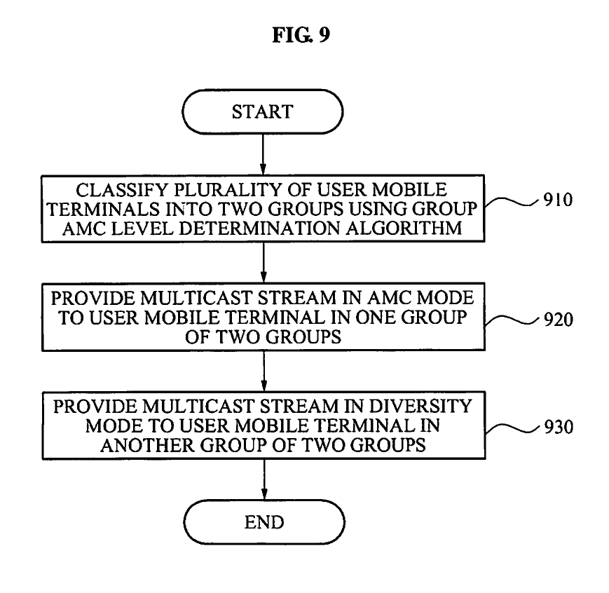

FIG. 9 is a flowchart illustrating a scheduling method according to an embodiment of the present invention. The scheduling method according to the present embodiment may be performed by the wireless communication system 800 according to a first example described with reference to FIG. 8.

In operation 910, the wireless communication system 800 classifies a plurality of user mobile terminals into two groups using a group AMC level determination algorithm. Here, the group AMC level determination algorithm may include an algorithm to select a user mobile terminal based on an AMC distribution of each of the user mobile terminals. Here, the user mobile terminals may include the mobile terminal described with reference to FIGS. 2 and 7. A method of classifying a plurality of user mobile terminals into two groups using the group AMC level determination algorithm may refer to FIG. 7. For example, the wireless communication system 800 may classify the plurality of user mobile terminals into one user mobile terminal group and another user mobile terminal group, the one user mobile terminal group including user mobile terminals selected by applying information about a channel state of each of the plurality of user mobile terminals and an average transmission rate to the group AMC level determination algorithm.

In operation 920 the wireless communication system 800 provides a multicast stream in an AMC mode to a user mobile terminal in one group of the two groups. That is, efficient multicast streaming may be provided to user mobile terminals selected by the group AMC level determination algorithm through a bandwidth of an AMC mode using a continuous feedback.

The wireless communication system 800 provides a multicast stream in a diversity mode to a user mobile terminal in another group of the two groups. That is, provision of multicast streaming to user mobile terminals which are not selected by the group AMC level determination algorithm, i.e., user mobile terminals with an inferior channel environment, may be more effective in a frequency use efficiency of a diversity mode using a diversity gain than in the AMC mode using the continuous channel feedback. Thus, the multicast streaming is provided using a bandwidth of the diversity mode to comparatively efficiently provide a multicast service to all user mobile terminals.

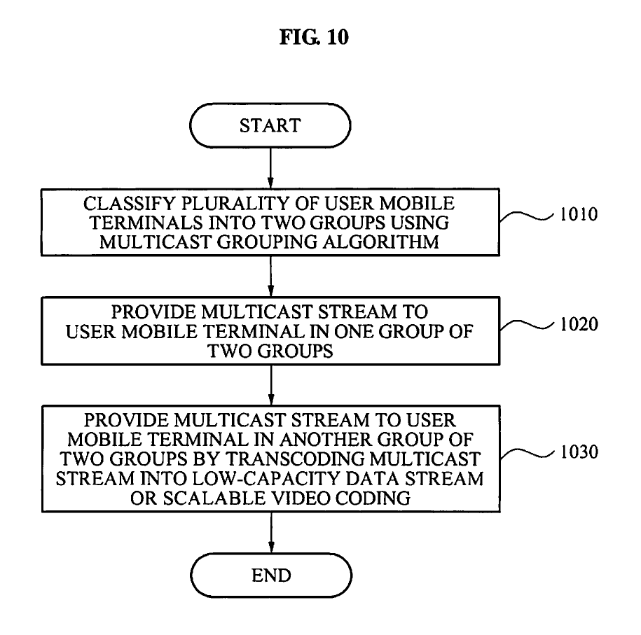

FIG. 10 is a flowchart illustrating a scheduling method according to another embodiment of the present invention. The scheduling method according to the present embodiment may be performed by the wireless communication system 800 according to a second example described with reference to FIG. 8.

In operation 1010, the wireless communication system 800 classifies a plurality of user mobile terminals into two groups based on a multicast grouping algorithm. Here, for example, the multicast grouping algorithm may include a group AMC level determination algorithm, and the wireless communication system 800 classifies the plurality of user mobile terminals into one user mobile terminal group and another user mobile terminal group, the one user mobile terminal group including user mobile terminals selected by applying information about a channel state of each of the plurality of user mobile terminals and an average transmission rate to the group AMC level determination algorithm. Here, the group AMC level determination algorithm may include an algorithm to select a user mobile terminal based on an AMC distribution of each of the user mobile terminals.

Although grouping a plurality of user mobile terminals is performed using the group AMC level determination algorithm in the above example, a plurality of user mobile terminals may be grouped using a preset critical value by an administrator as necessary into user mobile terminals having a critical value more than the preset critical value and user mobile terminals having a critical value not more than the preset critical value. In other words, any one of well-known multicast grouping schemes may be used as a grouping algorithm.

In operation 1020, the wireless communication system 800 transmits a multicast stream to a user mobile terminal in one group of the two groups. For example, the wireless communication system 800 may transmit the multicast stream in an AMC mode to the user mobile terminal in the one group.

In operation 1030, the wireless communication system 800 transmits a multicast stream to a user mobile terminal in another group of the two groups by transcoding the multicast stream into a low-capacity data stream or scalable video coding. For example, the wireless communication system 800 may transmit the multicast stream in a diversity mode to the user mobile terminal in the other group of the two groups.

That is, the wireless communication system 800 classifies a plurality of user mobile terminals into two groups, immediately transmits a multicast stream to user mobile terminals in one group, and transmits a multicast stream by changing the multicast stream into a low-capacity data stream or transmits a lowest class through scalable video coding to user mobile terminals in another group, thereby enabling provision of a multicast service even to user mobile terminals having an inferior channel state.

Although transmission of a multicast stream in an AMC mode and in a diversity mode has been described, the above examples are just an illustrative example. A multicast stream may be transmitted to a user mobile terminal in a group by different multicast transmission methods having different use efficiencies based on transmission rates or channel environments, respectively. In other words, a multicast transmission method to transmit a basic multicast stream and a multicast transmission method to transmit a basic multicast stream by transcoding the basic multicast stream into low-capacity data or scalable video coding may be used.

As described above, embodiments of the present invention enable all users participating in the multicast group to be provided with efficient service, and provide all of the users with a multicast service without missing any user.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A wireless communication system comprising:
a state identification unit to identify a congestion state of a network in response to a request for a multicast channel;
a modulation and coding selection (MCS) level determination unit to determine an MCS level based on whether the network is in a congestion state; and
a multicast unit to provide a multicast stream using the MCS level.

2. The wireless communication system of claim 1, wherein the MCS level determination unit determines the MCS level using a group MCS level determination algorithm when the network is in the congestion state.

3. The wireless communication system of claim 2, wherein the group MCS level determination algorithm comprises an algorithm to determine an MCS level of a group based on a data rate of a multicast stream needed for the group and an MCS level of each mobile terminal in the group in response to the request for the multicast channel.

4. The wireless communication system of claim 1, wherein the MCS level determination unit determines a minimum MCS level among an MCS level of each mobile terminal in a group as an MCS level of the group in response to the request for the multicast channel when the network is not in the congestion state.

5. The wireless communication system of claim 1, wherein the whether the network is in the congestion state is determined based on a saturation of a resource and a preset critical value of the saturation.

6. The wireless communication system of claim 1, wherein the multicast unit transmits the multicast stream in an adaptive modulation and coding (AMC) mode using the MCS level.

7. A wireless communication system comprising:
a user mobile terminal group classification unit to classify a plurality of user mobile terminals into two groups using a group AMC level determination algorithm;
a first multicast unit to provide a multicast stream in an AMC mode to a user mobile terminal in one group of the two groups; and
a second multicast unit to provide a multicast stream in a diversity mode to a user mobile terminal in another one group of the two groups.

8. The wireless communication system of claim 7, wherein the user mobile terminal group classification unit classifies the plurality of user mobile terminals into one user mobile terminal group and another user mobile terminal group, the one user mobile terminal group including user mobile terminals selected by applying information about a channel state of each of the plurality of user mobile terminals and an average transmission rate to the group AMC level determination algorithm.

9. The wireless communication system of claim 7, wherein the group AMC level determination algorithm comprises an algorithm to select a user mobile terminal based on an AMC distribution of each of the plurality of user mobile terminal.

10. A wireless communication system comprising:
a user mobile terminal group classification unit to classify a plurality of user mobile terminals into two groups based on a multicast grouping algorithm;
a first multicast unit to provide a multicast stream to a user mobile terminal in one group of the two groups; and
a second multicast unit to provide a multicast stream to a user mobile terminal in another group of the two groups by transcoding the multicast stream into a low-capacity data stream or scalable video coding.

11. The wireless communication system of claim 10, wherein the multicast grouping algorithm comprises a group AMC level determination algorithm, and the user mobile terminal group classification unit classifies the plurality of user mobile terminals into one user mobile terminal group and another user mobile terminal group, the one user mobile terminal group including user mobile terminals selected by applying information about a channel state of each of the plurality of user mobile terminals and an average transmission rate to the group AMC level determination algorithm.

12. The wireless communication system of claim 10, wherein the first multicast unit transmits the multicast stream in an AMC mode to the user mobile terminal in the one user mobile terminal group.

13. The wireless communication system of claim 10, wherein the second multicast unit transmits the multicast stream in a diversity mode to the user mobile terminal in the other user mobile terminal group of the two groups.
